(19) United States
(12) Patent Application Publication
(10) Pub. No.: US 2017/0141860 A1
(43) Pub. Date: May 18, 2017

(54) WIRELESS RELAY SYSTEM, WIRELESS RELAY METHOD, STORAGE MEDIUM IN WHICH WIRELESS RELAY PROGRAM IS STORED, AND WIRELESS RELAY STATION

(71) Applicant: NEC CORPORATION, Tokyo (JP)

(72) Inventor: Hideyuki FURUICHI, Tokyo (JP)

(73) Assignee: NEC CORPORATION, Tokyo (JP)

(21) Appl. No.: 15/321,526

(22) PCT Filed: Jun. 19, 2015
(86) PCT No.: PCT/JP2015/003085

§ 371 Date: Dec. 22, 2016

(30) Foreign Application Priority Data
Jun. 25, 2014 (JP) 2014-130222

(51) Int. Cl. H04B 17/40; H04W 52/52; H04W 52/46

(52) U.S. Cl. CPC H04B 17/40; H04W 52/46; H04W 52/52; H04W 88/04

(57) ABSTRACT

[Problem] To provide a wireless relay system, a wireless relay method, a wireless relay program, and a wireless relay station with which it is possible to relay a communication already being performed between a base station and a mobile communication terminal. [Solution] A communication means (21) receives a signal that a mobile communication terminal (30) and a base station (10) are mutually transmitting and receiving. A relay means (23) receives a signal transmitted by the mobile communication terminal (30) and transmits the received signal to the base station (10), and receives a signal transmitted to the mobile communication terminal (30) by the base station (10) and transmits the received signal to the mobile communication terminal (30).

### TECHNICAL FIELD

The present invention relates to a radio relay system, a radio relay method, a storage medium storing a radio relay program, and a radio relay station to relay mobile communication.

### BACKGROUND ART

In mobile communications services which are expected to spread in the future such as LTE-A (Long Term Evolution-Advanced), it is required to expand service areas and eliminate an insensible area to which a radio wave of a base station does not reach although the insensible area is within the service area of the base station.

Incidentally, there is a place where communication quality is low due to influence of such as fading even if it is within a service area in which a mobile terminal and a base station can communicate with each other. In order to improve communication quality of such place, introduction of a radio relay station (RN: Relay Node) which relays communication between a base station and a mobile terminal is being considered.

In patent literature 1, there is disclosed a system to control a radio relay station installed at a predetermined position and a movable radio relay station.

### CITATION LIST

### Patent Literature

[Patent Literature 1] International Publication WO 2011/135764

### SUMMARY OF INVENTION

### Technical Problem

Although a system disclosed in patent literature 1 relays communication that begins newly between a base station and a mobile terminal after a radio relay station is activated, it cannot relay communication which has been already started. Here, there is a case where an event is held at a place with low communication quality such as an indoor facility as the event site. Furthermore, when an event is held, there are actual conditions that participants would gather in the event site considerably before the start time of the event, for example. When such actual conditions are considered, it is desirable that communication started before the start of a radio relay station according to the start time of the event can be also relayed, for example.

Accordingly, an object of the present invention is to provide a radio relay system, a radio relay method, a storage medium storing a radio relay program and a radio relay station, capable of relaying communication which has been already started between a base station and a mobile terminal.

### Solution to Problem

A radio relay system, according to the present invention, comprises:

a mobile terminal;

a base station to communicate with the mobile terminal; and

a radio relay station comprising:

a communication means for receiving a signal being sent and received by the mobile terminal and the base station to and from each other; and

a relaying means for performing a relay operation to receive a signal transmitted by the mobile terminal to transmit the signal to the base station, and to receive a signal transmitted by the base station to the mobile terminal to transmit the signal to the mobile terminal.

A radio relay method, according to the present invention, comprises:

a communication step for receiving a signal being sent and received by a mobile terminal and a base station to and from each other; and

a relay step for performing a relay operation to receive a signal transmitted by the mobile terminal to transmit the signal to the base station, and to receive a signal transmitted by the base station to the mobile terminal to transmit the signal to the mobile terminal.

A storage medium, according to the present invention, storing a radio relay program to make

a computer execute:

communication processing to receive a signal being sent and received by a mobile terminal and a base station to and from each other;

identification information extraction processing to extract identification information for identifying the mobile terminal from the signal received in the communication processing; and

relay processing to perform a relay operation to receive a signal transmitted by the mobile terminal indicated by the identification information extracted in the identification information extraction processing to transmit the signal to the base station, and to receive a signal transmitted by the base station to the mobile terminal to transmit the signal to the mobile terminal.

The radio relay station, according to the present invention, comprises:

a communication means for receiving a signal being sent and received by a mobile terminal and a base station to and from each other; and

a relaying means for performing a relay operation to receive a signal transmitted by the mobile terminal to transmit the signal to the base station, and to receive a signal transmitted by the base station to the mobile terminal to transmit the signal to the mobile terminal.

### Advantageous Effects of Invention

According to the present invention, even when communication has been already started between a base station and a mobile terminal, a mobile radio relay station can relay communication between the base station and the mobile terminal.

### BRIEF DESCRIPTION OF DRAWINGS

FIG. 1 is a block diagram showing an exemplary configuration of a radio relay system of a first exemplary embodiment of the present invention.

FIG. 2 is a sequence diagram showing operations of a radio relay system of the first exemplary embodiment of the present invention.

FIG. 3 is a sequence diagram showing operations of a radio relay system of a second exemplary embodiment of the present invention.

FIG. 4 is a block diagram showing an exemplary configuration of a radio relay system of a third exemplary embodiment of the present invention.

### DESCRIPTION OF EMBODIMENTS

### Exemplary Embodiment 1

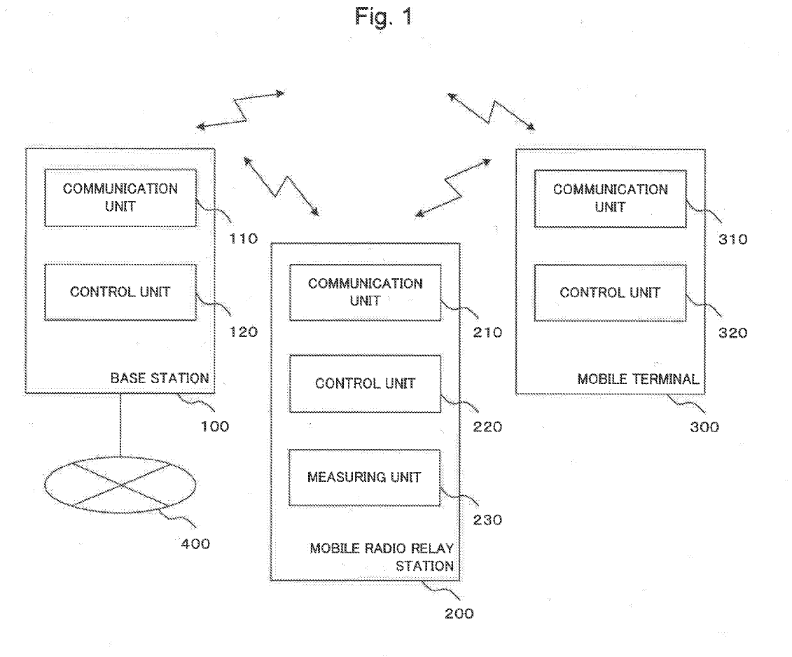

A radio relay system of the first exemplary embodiment of the present invention will be described with reference to drawings. FIG. 1 is a block diagram showing an exemplary configuration of a radio relay system of the first exemplary embodiment of the present invention. As shown in FIG. 1, a radio relay system of the first exemplary embodiment of the present invention includes a base station 100, a mobile radio relay station 200 and a mobile terminal 300.

The mobile terminal 300 is a mobile phone, for example. And, the base station 100 is a base station in a cellular phone communication service, for example.

The base station 100 is connected to a communication network 400. The mobile radio relay station 200 has a function to relay communication between the base station 100 and the mobile terminal 300. The mobile radio relay station 200 also has a function to move. Thus, the mobile terminal 300 sends and receives information to and from the base station 100 via the mobile radio relay station 200 or directly.

As shown in FIG. 1, the base station 100 includes a communication unit 110 and a control unit 120. The communication unit 110 of the base station 100 sends and receives information to and from the mobile terminal 300 via the mobile radio relay station 200 or directly following control of the control unit 120. Then, the communication unit 110 relays communication between the mobile terminal 300 and a server or the like (not shown) connected to the communication network 400. Meanwhile, the control unit 120 is a CPU (Central Processing Unit) which executes processing following program control, for example. Further, the communication unit 110 and the control unit 120 realize a power reducing means.

As shown in FIG. 1, the mobile radio relay station 200 includes a communication unit 210, a control unit 220 and a measuring unit 230. The communication unit 210 sends and receives information with the base station 100 and the mobile terminal 300 following control of the control unit 220. Thus, the communication unit 210 relays communication between the base station 100 and the mobile terminal 300. Meanwhile, the control unit 220 is a CPU which executes processing following program control, for example. The measuring unit 230 measures the received electric field strength of a signal transmitted by the mobile terminal 300 following control of the control unit 220.

As shown in FIG. 1, the mobile terminal 300 includes a communication unit 310 and a control unit 320. The communication unit 310 sends and receives information with the base station 100 via the mobile radio relay station 200 or directly following control of the control unit 320. Thus, the communication unit 310 communicates with a server or the like (not shown) connected to the communication network 400. Meanwhile, the control unit 320 is a CPU which executes processing following program control, for example. Further, the communication unit 310 and the control unit 320 realize a power reducing means.

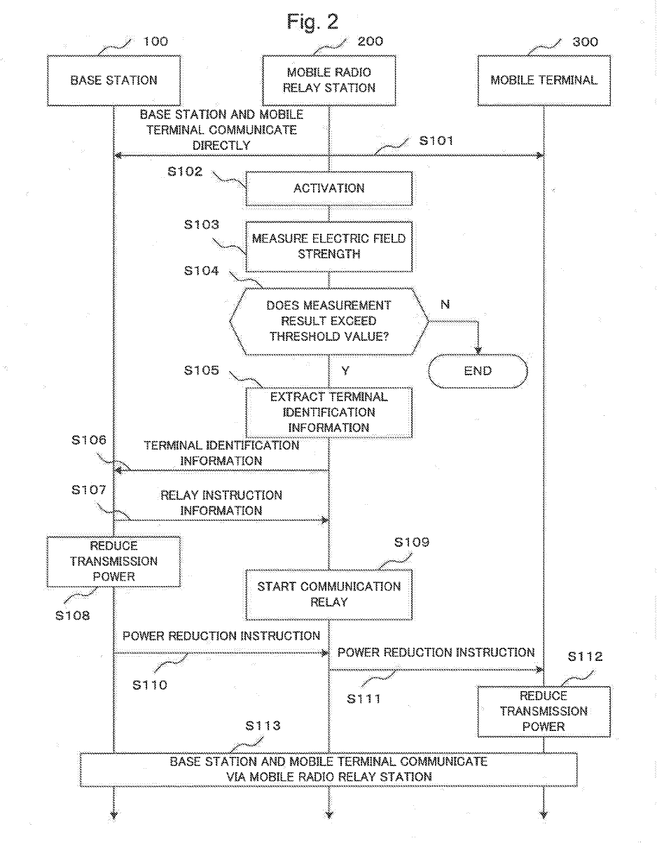

Next, operations of a radio relay system of the first exemplary embodiment of the present invention will be described. FIG. 2 is a sequence diagram showing operations of a radio relay system of the first exemplary embodiment of the present invention.

First, when the base station 100 and the mobile terminal 300 are sending and receiving information directly with each other (Step S101), the mobile radio relay station 200 moves to a position at which communication with the base station 100 and the mobile terminal 300 is possible and is activated (Step S102). Meanwhile, a relaying position by the mobile radio relay station 200 is determined, for example, based on measurement results of the received electric field strength of a signal emitted from the base station 100 and the received electric field strength of a signal emitted from the mobile terminal 300. Specifically, it is a place at which a difference between the received electric field strength of a signal emitted from the base station 100 and the received electric field strength of a signal emitted from the mobile terminal 300 is within a predetermined value, for example. In addition, a connection state between the base station 100 and the mobile terminal 300 in Step S101 may be a standby state (RRC (Radio Resource Control) idle state, for example) or may be a during-communication state (RRC Connected state, for example).

When the communication unit 210 receives a signal emitted from the mobile terminal 300, the control unit 220 of the mobile radio relay station 200 makes the measuring unit 230 measure the received electric field strength of the signal (Step S103).

When the received electric field strength measured by the measuring unit 230 exceeds a predetermined threshold value in the processing of Step S103 (Y in Step S104), the control unit 220 of the mobile radio relay station 200 makes the communication unit 210 carry out the following processing. That is, the control unit 220 makes the communication unit 210 demodulate the received signal to extract terminal identification information (RNTI (Radio Network Temporary Identity), for example) for identifying the mobile terminal 300 (Step S105). Then, the control unit 220 makes the communication unit 210 transmit the extracted terminal identification information to the base station 100 (Step S106).

Meanwhile, the threshold value may be set to the control unit 220 of the mobile radio relay station 200 in advance, or may be set by the base station 100.

When the communication unit 110 receives terminal identification information transmitted in the processing of Step S106, the control unit 120 of the base station 100 performs the following processing. That is, the control unit 120 makes the communication unit 110 transmit to the mobile radio relay station 200 relay instruction information to direct relaying of communication with the mobile terminal 300 indicated by the terminal identification information (Step S107).

Also, the control unit 120 of the base station 100 makes the communication unit 110 reduce transmission power of a signal used for communication with the mobile terminal 300 from the transmission power at the time of communicating in Step S101 (Step S108). Specifically, in the processing of Step S108, the control unit 120 makes the communication unit 110 reduce transmission power to lower transmission power within a range capable of communicating with the mobile radio relay station 200, for example.

When the communication unit 210 receives the relay instruction information transmitted in the processing of Step S107, the control unit 220 of the mobile radio relay station 200 begins to relay communication between the base station 100 and the mobile terminal 300 (Step S109). Specifically, when the mobile terminal 300 is being indicated by the terminal identification information which has been extracted by demodulating a signal received by the communication unit 210, the mobile radio relay station 200 relays the received signal by amplifying it to a predetermined power and transmitting it. Meanwhile, relaying by the mobile radio relay station 200 is begun in such a way that processing corresponding to a handover in a cellular phone communication service is performed, for example.

In addition, the control unit 120 of the base station 100 makes the communication unit 110 transmit a power reduction instruction for reducing the transmission power of a signal to the mobile terminal 300 (Step S110). Specifically, in the processing of Step S110, the control unit 120 makes the communication unit 110 transmit the power reduction instruction which directs reduction to lower transmission power within a range capable of communicating with the mobile radio relay station 200, for example. The communication unit 210 of the mobile radio relay station 200 relays the power reduction instruction transmitted by the communication unit 110 of the base station 100 in the processing of Step S110 (Step S111).

When the communication unit 310 receives the power reduction instruction which has been transmitted by the processing of Step S110 and relayed by the processing of Step S111, the control unit 320 of the mobile terminal 300 makes the communication unit 310 reduce the transmission power of a signal in later communication from that of the past (Step S112).

Then, communication between the base station 100 and the mobile terminal 300 is relayed by the mobile radio relay station 200 (Step S113).

According to this exemplary embodiment, the mobile radio relay station 200 extracts identification information from a signal transmitted by the mobile terminal 300. Then, the mobile radio relay station 200 begins to relay communication between the base station 100 and the mobile terminal 300 based on the extracted identification information. Accordingly, even when communication has been already started between the base station 100 and the mobile terminal 300, the mobile radio relay station 200 can relay communication between the base station 100 and the mobile terminal 300.

In addition, according to this exemplary embodiment, the base station 100 and the mobile terminal 300 reduce transmission power after having started relaying by the mobile radio relay station 200. Accordingly, radio interference by the base station 100 and radio interference by the mobile terminal 300 can be suppressed well. Moreover, power consumption in the base station 100 and the mobile terminal 300 can be reduced well. Here, the base station 100 and the mobile terminal 300 output a signal at transmission power proportional to the square of a distance to a communication party. Then, suppose that a distance between the base station 100 and the mobile radio relay station 200 is x, and a distance between the mobile radio relay station 200 and the mobile terminal 300 is y.

In that case, when the base station 100 and the mobile terminal 300 communicate directly, signals are outputted from each other by transmission power proportional to the square of the distance (x+y), ((x+y)²=x²+2xy+y²), between the base station 100 and the mobile terminal 300. In contrast, when the mobile radio relay station 200 relays communication between the base station 100 and the mobile terminal 300, a signal is outputted from each other by transmission power proportional to the sum (x²+y²) of the square (x²) of the distance (x) between the base station 100 and the mobile radio relay station 200 and the square (y²) of the distance (y) between the mobile radio relay station 200 and the mobile terminal 300.
Accordingly, when the mobile radio relay station 200 relays communication between the base station 100 and the mobile terminal 300, power consumption can be reduced well compared with that of a case when communication is performed directly between the base station 100 and the mobile terminal 300.

Meanwhile, the processing of Step S109 in the mobile radio relay station 200 may be configured such that it is performed after a reception reply of terminal identification information transmitted to the base station 100 in the processing of Step S106 has been received. Also, the processing of Step S108 in the base station 100 may be configured such that it is performed after a reception reply of relay instruction information transmitted to the mobile radio relay station 200 in the processing of Step S107 has been received. The processing of Step S113 in the base station 100 may be configured such that it is performed after a reception reply of a power reduction instruction transmitted to the mobile radio relay station 200 in the processing of Step S110 has been received. Furthermore, the processing of Step S113 in the mobile radio relay station 200 may be configured such that it is performed after a reception reply of a power reduction instruction transmitted to the mobile terminal 300 in the processing of Step S111 has been received. When being constituted such that later processing is performed after a reception reply has been received, it is possible to make each piece of processing progress certainly, and begin communication between the base station 100 and the mobile terminal 300 via the mobile radio relay station 200 more certainly.

Meanwhile, the mobile radio relay station 200 is realized in a manner that the communication unit 210, the control unit 220 and the measuring unit 230 are provided in an airframe such as an airship, a vehicle, a public transportation and other mobile terminals, for example. When those are provided in an airframe such as an airship, the communication quality can be improved by staying in the sky over the event site and relaying communication between the base station 100 and the mobile terminal 300, for example. Also, when those are provided in a vehicle, the communication quality can be improved by moving to various places of such as an event site to relay communication between the base station 100 and the mobile terminal 300, for example. When those are provided in a public transportation, the communication quality can be improved by relaying communication between the base station 100 and the passenger's mobile terminal 300. Meanwhile, the processing for the mobile radio relay station 200 to move and carry out handover to another base station is performed by the mobile terminal 300 and the base station in question and the like.

The mobile radio relay station 200 is not needed to be removable necessarily, and it may be constituted such that it is installed in a neighborhood of such as an event site fixedly, and is used according to holding of events to relay communication between the mobile terminal 300 and the base station 100.

Meanwhile, in the processing of Step S106, the communication unit 210 of the mobile radio relay station 200 may transmit to the base station 100 terminal identification information including measurement result information which indicates a measurement result of the electric field strength by the measuring unit 230 in Step S103. Then, the control unit 120 of the base station 100 may determine a rate of reducing transmission power in the processing of Step S108 based on the electric field strength indicated by the measurement result information. In addition, in a power reduction instruction to be transmitted in the processing of Step S110, the control unit 120 of the base station 100 may direct the mobile terminal 300 to reduce transmission power at a rate according to the electric field strength indicated by the measurement result information.

### Exemplary Embodiment 2

Next, a radio relay system of the second exemplary embodiment of the present invention will be described. In a radio relay system of the first exemplary embodiment, the mobile radio relay station 200 extracts terminal identification information from a signal emitted from the mobile terminal 300 and relays the signal including the terminal identification information. On the other hand, in a radio relay system of this exemplary embodiment, it is possible for the mobile radio relay station 200 to start relay of communication between the base station 100 and the mobile terminal 300 quickly.

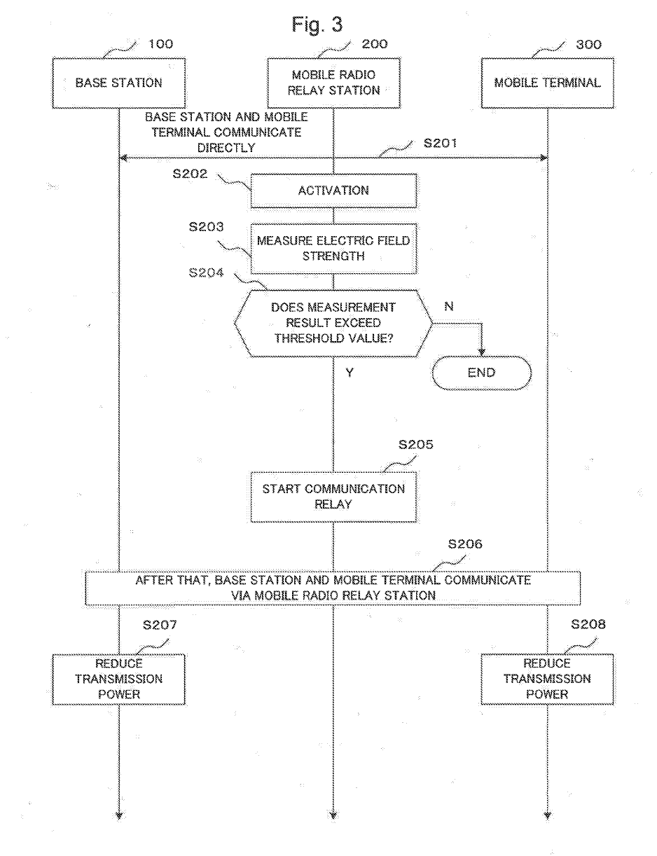

FIG. 3 is a sequence diagram showing operations of a radio relay system of the second exemplary embodiment of the present invention. Since the pieces of processing of Steps S201-S204 of the base station 100, the mobile radio relay station 200 and the mobile terminal 300 in this exemplary embodiment are similar to those pieces of the processing of Steps S101-S104 shown in FIG. 2, respectively, description will be omitted.

When the received electric field strength measured by the measuring unit 230 in the processing of Step S203 exceeds a predetermined threshold value (Y in Step S204), the mobile radio relay station 200 begins to relay communication between the base station 100 and the mobile terminal 300 (Step S205). Specifically, the mobile radio relay station 200 amplifies a signal received by the communication unit 210 to predetermined power and transmits it to carry out relay.

Then, when the base station 100 and the mobile terminal 300 perform communication via the mobile radio relay station 200 (Step S206), a signal emitted by the mobile terminal 300 is amplified by the mobile radio relay station 200, and, therefore, the received electric field strength in the base station 100 becomes large. Then, according to the received electric field strength, the control unit 120 of the base station 100 makes the communication unit 110 reduce transmission power to lower power (Step S207).

In addition, when the base station 100 and the mobile terminal 300 perform communication via the mobile radio relay station 200 (Step S206), the received electric field strength in the mobile terminal 300 becomes large because a signal emitted by the base station 100 is amplified by the mobile radio relay station 200. Then, according to the received electric field strength, the control unit 320 of the mobile terminal 300 makes the communication unit 310 reduce transmission power to lower power (Step S208).

According to this exemplary embodiment, the same effect as the effect in the first exemplary embodiment can be exerted. Also, according to this exemplary embodiment, since communication relay is begun without the mobile radio base station 200 performing sending and receiving and the like of terminal identification information, communication relay is begun more quickly.

### Exemplary Embodiment 3

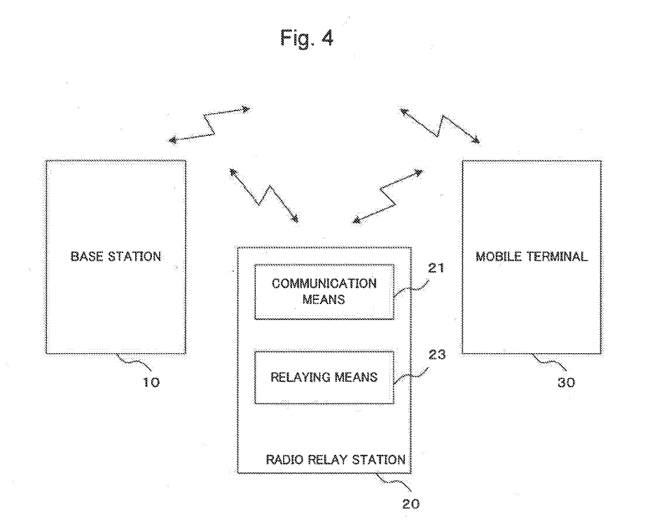

Next, a radio relay system of the third exemplary embodiment of the present invention will be described with reference to a drawing. FIG. 4 is a block diagram showing an exemplary configuration of a radio relay system of the third exemplary embodiment of the present invention. As shown in FIG. 4, a radio relay system of the third exemplary embodiment of the present invention includes a base station 10, a radio relay station 20 and a mobile terminal 30.

The radio relay station 20 includes a communication means 21 and a relaying means 23.

The communication means 21 (this corresponds to the communication unit 210 shown in FIG. 1) receives a signal which the mobile terminal 30 and the base station 10 are sending and receiving to and from each other.

The relaying means 23 (this corresponds to the communication unit 210 and the control unit 220 shown in FIG. 1) performs a relay operation to receive a signal transmitted by the mobile terminal 30 and transmit it to the base station 10, and to receive a signal transmitted by the base station 10 to the mobile terminal 30 and transmit it to the mobile terminal 30.

According to this exemplary embodiment, even when communication has been already started between the base station 10 and the mobile terminal 30, the mobile radio relay station 20 can relay communication between the base station 10 and the mobile terminal 30.

The whole or part of the exemplary embodiments disclosed above can be described as, but not limited to, the following supplementary notes.

(Supplementary note 1)

A radio relay station, comprising:

a communication means for receiving a signal being sent and received by a mobile terminal and a base station to and from each other;

an identification information extraction means for extracting identification information for identifying the mobile terminal from the signal received by the communication means; and

a relaying means for performing a relay operation to receive a signal transmitted by the mobile terminal indicated by the identification information extracted by the identification information extraction means to transmit the signal to the base station, and to receive a signal transmitted by the base station to the mobile terminal to transmit the signal to the mobile terminal.

### (Supplementary Note 2)

The radio relay station according to Supplementary note 1 further comprising:

a measuring means for measuring electric field strength of a signal received by the communication means from the mobile terminal, wherein

the relaying means performs the relay operation when a measurement result of electric field strength by the measuring means exceeds a predetermined threshold value.

### (Supplementary Note 3)

The radio relay station according to Supplementary note 1 or 2, wherein,

in the relay operation, the relaying means amplifies and transmits a received signal.

### (Supplementary Note 4)

The radio relay station according to any one of Supplementary notes 1 to 3, wherein

the relaying means directs the mobile terminal to reduce transmission power according to a direction of the base station.

### (Supplementary Note 5)

The radio relay station according to any one of Supplementary notes 1 to 4, wherein

the relaying means directs reduction of transmission power to the mobile terminal after having begun the relay operation.

### (Supplementary Note 6)

A radio relay method, comprising:

a communication step of receiving a signal being sent and received by a mobile terminal and a base station to and from each other; and

an identification information extraction step of extracting identification information for identifying the mobile terminal from the signal received in the communication step; and

a relaying step of performing a relay operation to receive a signal transmitted by the mobile terminal indicated by the identification information extracted in the identification information extraction step to transmit the signal to the base station, and to receive a signal transmitted by the base station to the mobile terminal to transmit the signal to the mobile terminal.

### (Supplementary Note 7)

A radio relay program to make

a computer execute:

communication processing to receive a signal being sent and received by a mobile terminal and a base station to and from each other;

identification information extraction processing to extract identification information for identifying the mobile terminal from the signal received in the communication processing; and

relay processing to perform a relay operation to receive a signal transmitted by the mobile terminal indicated by the identification information extracted in the identification information extraction processing to transmit the signal to the base station, and to receive a signal transmitted by the base station to the mobile terminal to transmit the signal to the mobile terminal.

### (Supplementary Note 8)

A radio relay system, comprising:

a mobile terminal;

a base station to communicate with the mobile terminal; and

a radio relay station comprising:

a communication means for receiving a signal being sent and received by the mobile terminal and the base station to and from each other;

an identification information extraction means for extracting identification information for identifying the mobile terminal from the signal received by the communication means; and

a relaying means for performing a relay operation to receive a signal transmitted by the mobile terminal indicated by the identification information extracted by the identification information extraction means to transmit the signal to the base station, and to receive a signal transmitted by the base station to the mobile terminal to transmit the signal to the mobile terminal.

### (Supplementary Note 9)

A mobile terminal, comprising

a power reducing means for reducing transmission power of a signal following a direction by a radio relay station, the radio relay station including: a communication means for receiving a signal being sent and received by a self-mobile terminal and a base station to and from each other; an identification information extraction means for extracting identification information for identifying the mobile terminal from the signal received by the communication means; and a relaying means for performing a relay operation to receive a signal transmitted by the mobile terminal indicated by the identification information extracted by the identification information extraction means to transmit the signal to the base station, and to receive a signal transmitted by the base station to the mobile terminal to transmit the signal to the mobile terminal.

### (Supplementary Note 10)

A base station, comprising

a power reducing means for reducing transmission power of a signal when, by a radio relay station including: a communication means for receiving a signal being sent and received by a self-mobile terminal and a base station to and from each other; an identification information extraction means for extracting identification information for identifying the mobile terminal from the signal received by the communication means; and a relaying means for performing a relay operation to receive a signal transmitted by the mobile terminal indicated by the identification information extracted by the identification information extraction means to transmit the signal to the base station, and to receive a signal transmitted by the base station to the mobile terminal to transmit the signal to the mobile terminal, the relay operation is begun.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-130222, filed on Jun. 25, 2014, the disclosure of which is incorporated herein in its entirety by reference.

### REFERENCE SIGNS LIST

10, 100 Base station
20 Radio relay station
21 Communication means
23 Relaying means
30, 300 Mobile terminal
110, 210, 310 Communication unit
120, 220, 320 Control unit
200 Mobile radio relay station
230 Measuring unit
400 Communication network

1. A radio relay system, comprising:
a mobile terminal;
a base station to communicate with the mobile terminal; and
a radio relay station comprising:
a communication unit for receiving a signal being sent and received by the mobile terminal and the base station to and from each other; and
a relaying unit for performing a relay operation to receive a signal transmitted by the mobile terminal to transmit the signal to the base station, and to receive a signal transmitted by the base station to the mobile terminal to transmit the signal to the mobile terminal.

2. The radio relay system according to claim 1, further comprising:
a measuring unit for measuring electric field strength of a signal received by the communication unit from the mobile terminal, wherein
the relaying unit performs the relay operation when a measurement result of electric field strength by the measuring unit exceeds a predetermined threshold value.

3. The radio relay system according to claim 1, wherein,
in the relay operation, the relaying unit amplifies and transmits a received signal.

4. The radio relay system according to claim 1, wherein
the mobile terminal reduces transmission power according to electric field strength of a received signal.

5. The radio relay system according to claim 1, wherein
the base station reduces transmission power according to electric field strength of a received signal.

6. A radio relay method, comprising:
receiving a signal being sent and received by a mobile terminal and a base station to and from each other; and
performing a relay operation to receive a signal transmitted by the mobile terminal to transmit the signal to the base station, and to receive a signal transmitted by the base station to the mobile terminal to transmit the signal to the mobile terminal.

7. (canceled)

8. The radio relay station, comprising:
a communication unit for receiving a signal being sent and received by a mobile terminal and a base station to and from each other; and
a relaying unit for performing a relay operation to receive a signal transmitted by the mobile terminal to transmit the signal to the base station, and to receive a signal transmitted by the base station to the mobile terminal to transmit the signal to the mobile terminal.
